(19) United States
(12) Patent Application Publication
(10) Pub. No.: US 2026/0339283 A1
(43) Pub. Date: Oct. 29, 2026

(54) Method for User Guidance for a Process Change, Computer Program Product and System

(71) Applicant: Windmöller & Hölscher KG, Lengerich (DE)

(72) Inventors: Daniel Niehues, Lengerich (DE); Tobias Kulgemeyer, Lengerich (DE); Till Bergmann, Lengerich (DE)

(21) Appl. No.: 19/109,930

(22) PCT Filed: Sep. 8, 2023
(86) PCT No.: PCT/EP2023/074794

§ 371 Date: Mar. 7, 2025

(30) Foreign Application Priority Data
Sep. 9, 2022 (DE) 10 2022 123 023.6

(51) Int. Cl. G05B 15/02

(52) U.S. Cl. CPC G05B 15/02

(57) ABSTRACT

The invention relates to a method (100) for user guidance during a process change from a manufacturing process (200) for manufacturing a first film material (201) to a subsequent process (210) for manufacturing a second film material (211) in an extrusion device (10). The invention also relates to a computer program product and a system (1).

The invention relates to a method for user guidance for a process change in an extrusion device, a computer program product and a system for user guidance for a process change.

It is generally known that different products can be manufactured using extrusion devices in the form of film machines. The products usually differ from one another due to their different recipes. This means that a series of different orders with different recipes are processed sequentially one after the other. For transition between two recipes, a change is made from a recipe currently in use to a subsequent recipe. In known solutions, this change is usually carried out manually and based on the experience of the machine operator.

The disadvantage of such solutions is that the quality and, above all, the time required for the implementation of the change from one recipe to the next is based solely on the knowledge of the machine operator. This means that a very high rejection rate can be achieved for this change between recipes, particularly with inexperienced machine operators. In particular, it is not possible to achieve a clear and continuous quality requirement for all changes to subsequent recipes in this way. Last but not least, the possibility of errors cannot be ruled out.

It is therefore known from DE 10 2015 108 972 A1 to guide a machine operator stage/step by stage/step during a recipe change. This avoids incorrect strategies or incorrect sequences of individual change stages within the change of recipes, particularly for a machine operator with little experience, or significantly reduces the risk of such an incorrect assignment. However, it is desirable to provide both inexperienced and experienced machine operators with meaningful support during a process change.

It is an object of the present invention to at least partially eliminate the above disadvantages known from the prior art. In particular, it is an object of the present invention to provide an improved user guidance for a process change of an extrusion device, which preferably provides a machine operator with an overview of the ongoing manufacturing process and at the same time simplifies the process change.

The above problem is solved by a method having the features of claim 1, a computer program product having the features of claim 17, and a system having the features of claim 18. Further features and details of the invention are apparent from the respective dependent claims, the description and the drawings. Features and details which are described in connection with the method according to the invention naturally also apply in connection with the computer program product according to the invention and/or the system according to the invention and vice versa, so that reference is or can always be made to the individual aspects of the invention with respect to the disclosure.

According to a first aspect of the invention, there is provided a method for user guidance for a process change from a manufacturing process for manufacturing a first film material to a subsequent process for manufacturing a second film material in an extrusion device. The method comprises, in particular in the form of method stages:
capturing of a process parameter set of the manufacturing process for manufacturing the first film material, in particular by a control system and/or a sensor system of the extrusion device,
determining a setpoint subsequent parameter set of the subsequent process assigned to the process parameter set, in particular by retrieving the process parameter set from a memory device of the control system,
identifying of comparative data of a comparison of the process parameter set with the setpoint subsequent parameter set for detecting deviations of the setpoint subsequent parameter set from the process parameter set, in particular by the control system,
outputting of display data for the joint display of several comparison elements to show the deviations based on the comparative data during the manufacturing process, in particular by the control system,
capturing of a user interaction for controlling the extrusion device for at least a partial or complete adjustment of the process parameter set, in particular by the control system,
updating the display data, in particular the comparison elements, depending on the adjustment of the process parameter set, preferably during the manufacturing process, in particular by the control system.

The extrusion device can advantageously be a film machine, in particular a cast film machine and/or a blown film machine. The extrusion device may comprise one or more extruders for heating, mixing and/or conveying raw material.

Preferably, the first and second film materials are each in the form of a plastic film. The first film material and the second film material can preferably differ in a formulation, i.e. in particular in a material composition, and/or in a format. For example, different raw materials and/or different quantities of raw materials can be used for the first and second film materials. The format can preferably be understood as a geometric configuration, such as a film width and/or film thickness, of the first and second film material. A production result of the manufacturing process can comprise a first film product, e.g. a tubular and/or flat film, and a production result of the subsequent process can comprise a second film product, e.g. a tubular and/or flat film. The first and second film products can each be produced and/or processed in individual film sections or contiguously. It may be provided that a type of process change is recognized by determining whether the process change comprises a format change and/or a material change. The display data and/or the comparison elements can be determined depending on a type of process change, in particular in order to provide adapted operating pages.

The manufacturing process and the subsequent process can each comprise a manufacturing job. The process change can preferably take place without stopping the extrusion device, so that the manufacturing process and the subsequent process merge into one another and/or film material is permanently produced. The manufacturing process is understood in particular to mean a good production of the first film material, i.e. a production of the first film material which satisfies at least one quality criterion for the first film material, in particular for the sale of the first film material. The subsequent process is understood in particular to be a good production of the second film material, i.e. a production of the second film material which satisfies at least one quality criterion for the second film material, in particular for the sale of the second film material. Between the manufacturing process and the subsequent process, a changeover process can be carried out in which only material waste is produced which satisfies neither the quality criterion for the first film material nor the quality criterion for the second film material. The changeover process is preferably minimized by the method according to the invention.

The process parameter set can comprise one or more process parameters of actual machine data and/or target machine data of the extrusion device, in particular in the form of sensor data and/or control and/or regulation data, for the manufacturing process. For example, the Process parameter set may comprise temperature data of the extrusion device and/or material conveying data of the extrusion device, in particular in the form of a conveying speed and/or an extruder rotational speed. It may be provided that the process parameter set is captured and preferably updated continuously or discontinuously, in particular during the manufacturing process. Preferably, the process parameter set is captured in real time during the manufacturing process.

The setpoint subsequent parameter set can comprise one or more setpoint sequence parameters of setpoint machine data of the extrusion device, in particular in the form of control and/or regulation data, for the subsequent process. In particular, the setpoint subsequent parameter set may comprise temperature data of the extrusion device and/or material conveying data of the extrusion device, in particular in the form of a conveying speed and/or an extruder rotational speed. Thus, the setpoint subsequent parameter set may comprise one or more setpoint sequence parameters which are assigned to the one or more process parameters of the process parameter set, but which relate to the subsequent process. When determining the setpoint subsequent parameter set, the setpoint subsequent parameter set can, for example, be retrieved from a memory device and/or from a database. However, it is also conceivable that the setpoint subsequent parameter set is captured by a user input, in particular on the extrusion device.

To identify the comparative data, for example, a difference between the target sequence parameters and the process parameters can be calculated. The comparison elements can advantageously comprise a qualitative and/or quantitative representation of the comparative data. For example, the comparison elements may comprise a display of a value of the difference between the target sequence parameters and the process parameters. However, it is also conceivable that the deviations from the comparative data in the display data are represented in color by the comparison elements. The joint display of the comparison elements can be understood as a simultaneous display of several deviations, in particular in one view. The display data can include a user interface in which the comparison elements with the deviations are integrated, in particular graphically. When outputting the display data, the display data can, for example, be displayed on a display device or sent to a display device. It is conceivable that the output of the display data comprises a display of the display data directly on the extrusion device and/or a display on a control station. When the display data is updated, the display data can be output again. The display data can also comprise additional information, such as order data and/or recipe data for the first and/or second film material.

It may be provided that the extrusion device is controlled manually and/or actively, in particular electronically, depending on the user interaction. The user interaction can be captured by capturing a user input, in particular at the extrusion device. For example, the user interaction can comprise a control action and/or data communication for controlling the extrusion device. Furthermore, the user interaction can be captured by capturing a confirmation of the execution of the user interaction, in particular at the display device. The adaptation of the process parameter set can comprise an at least partial or complete adjustment of one or more, preferably all, process parameters of the process parameter set to the respectively assigned target sequence parameters of the setpoint subsequent parameter set. In particular, the capturing of the user interaction and/or the updating of the display data can be carried out continuously or discontinuously in a repetitive manner.

Thus, the method comprises in particular a dynamic process control for the interaction of a user with the extrusion device during the ongoing manufacturing process in order to prepare the subsequent process. As a result, a process change can be shortened, in particular with regard to a changeover time and/or material consumption. By joint displaying the comparison elements during the manufacturing process, both experienced and inexperienced users can obtain a comprehensive overview of the current process parameter set as well as the adjustments to be made for the subsequent process. With the user interaction, a user can be free to decide which detectable adjustments the user makes based on the display data from the comparative data. It may be provided that the display data, in particular the comparison elements, include a commentary on the deviations. This allows less experienced users, for example, to be guided by the display data to a greater extent than experienced users. At the same time, outputting the display data during the manufacturing process also provides an overview of the current manufacturing process, so that process reliability can be ensured until the process change and/or the manufacturing process is completed. By updating the display data, it is also possible to constantly check whether the current adjustments meet the requirements of the manufacturing process and/or the subsequent process. As a result, operating errors and/or unfavorable operating actions can be detected to enable a counter-reaction. In addition, a user can detect at any time how the user interaction affects other process parameters, allowing subsequent user interactions to be adapted accordingly. The measures preparing for the process change can at least partially shift the process change into the manufacturing process and thus preferably blur a boundary between the manufacturing process and the subsequent process.

Furthermore, in a method according to the invention, it may advantageously be provided that the process parameter set and/or the comparison elements comprise material data of material ingredients and/or sensor data of sensors of the extrusion device. The sensor data may comprise, for example, motor current values of an electric motor, temperature values and/or a temperature curve at a component of the extrusion device and/or the like. The sensor data are thus in particular actual process parameters that can be compared with target/setpoint sequence parameters for the subsequent process. This can be used to recognize at any time how far the process change has been implemented on the extrusion device. The sensor data can also include image data, in particular for detecting a bubble shape. The material data can be, for example, a material type, a material composition, in particular with percentages of the material ingredients, and/or material properties, such as a viscosity of the material ingredients. In particular, the material ingredients can be understood as raw materials of the manufacturing process. When comparing the process parameter set with the setpoint subsequent parameter set, a comparison of the material data for the manufacturing process and the subsequent process can be used to identify, for example, a rinsing preparation and/or a required temperature adjustment for the subsequent process. This can make it easier to change the material of a raw material from the manufacturing process to the subsequent process.

It is also conceivable in a method according to the invention that the method comprises the following stage:
determining at least one recommended action for adjusting the process parameter set, preferably during the manufacturing process, for the subsequent process depending on the comparative data,
   in particular wherein the recommended action is output with the, preferably updated, display data, in particular by the control system and/or a display device. The recommended action can be integrated into the display data and/or can be displayed in addition to the display data. It is conceivable that the recommended action is configured as a comment in the display data. For example, the recommended action can be in text form or highlighted in the display data. For example, control fields, such as buttons, can be highlighted in the display data for the recommended action. Furthermore, the recommended action can be outputted before and/or after the user interaction. In particular, when determining the recommended action, the user interaction can be evaluated depending on a process condition of the manufacturing process and/or the subsequent process. The process condition may comprise a quality criterion of the first and/or second film material and/or a process stability criterion. The recommended action can therefore enable improved interaction between an operator and the manufacturing process in order to execute and/or prepare the process change. It may be provided that the recommended action includes a process warning. Preferably, a current configuration of the process parameter set can be retained until the user confirms the process warning, in particular to prevent incorrect process control and any resulting process shutdown. Preferably, the recommended action is determined depending on a target variable, in particular one that is to be optimized, in particular where the target variable comprises a material quantity, a changeover time of the process change, a quality criterion for the first film material and/or the second film material and/or a process reliability when implementing the process change. The material quantity can refer to a material ingredient, i.e. in particular a raw material, for the first and/or second film material. However, it is also conceivable that the target variable comprises a material quantity of a film material produced by the extrusion device, i.e. in particular a starting material.

Furthermore, in a method according to the invention, it may advantageously be provided that the recommended action comprises a manual activity and/or a recommendation for controlling the extrusion device. In particular, the recommended action can be understood as an instruction for operating the extrusion device and/or for carrying out a preparatory action. The manual activity may, for example, comprise maintenance work, in particular in the form of cleaning activities and/or emptying at least one filter, on the extrusion device. Furthermore, the manual activity can include material procurement. For example, the user can be instructed by the recommended action to bring a subsequent material from a store to the extrusion device or to reposition a suction lance to supply the extrusion device with a raw material. The recommended control of the extrusion device can preferably be executed directly via the control system and/or the display device. For example, the comparative data may include links to control instructions so that a user can interact directly with the extrusion device and/or the display data.

Furthermore, in a method according to the invention, it may advantageously be provided that the method comprises the following stages:
planning at least one process course for the manufacturing process and/or the subsequent process depending on the comparative data, in particular by the control system and/or the display device,
   in particular wherein the recommended action is determined depending on the process course and/or several process courses. The process course can comprise a desired flow and/or a prediction of a remaining part of the manufacturing process, in particular at the time of planning the process course, and/or the subsequent process. In particular, the process change can be mapped by the process course. The process course can advantageously be output with the display data. In this way, the process course can form a flow chart for the operator. The process course can also be used to check the influence of the recommended action on the process parameters of the process parameter set in order to determine the recommended action. In particular, several possible process courses can be simulated to determine the recommended action. This allows complex correlations to be recognized during the manufacturing process and an improved recommended action to be determined

In a method according to the invention, it is also conceivable that the process course for defining temporal modification comprises a temporal course of the process parameter set, with the display data being output and/or the recommended action being determined depending on the temporal course. In particular, a system reaction of the extrusion device depending on the at least partial adjustment of the process parameter set can be represented by the temporal course. For example, the process course can include an increase in the temperature of a machine component until a target temperature is reached and/or a material consumption until a defined filling level of a storage container and/or a silo is reached. In particular, the temporal course for each of the process parameters of the process parameter set can be mapped by the process course. In particular, the time can thus be defined as a uniform scale for the process parameter set. This also allows different process parameters of the process parameter set to be mapped for the process change and processes for adjusting the process parameter set to be at least partially parallelized and/or ordered in time. It is also conceivable that external events, such as a planned shift change and/or a maintenance interval of the extrusion device, are taken into account for the definition of the temporal modification when planning the process course.

Furthermore, it is conceivable in a method according to the invention that, when determining the recommended action, several recommended actions are identify to define an action sequence, in particular where the action sequence comprises a chronological order of the recommended actions. Each of the recommended actions can relate to a user interaction required for the process change. The action sequence can be at least partially related to the manufacturing process. Furthermore, the action sequence can extend beyond the manufacturing process into the subsequent process. Preferably, the chronological order is determined based on the process course and/or based on a prioritization of the recommended actions. The prioritization can be based on the target variable, for example. Prioritization can, for example, prevent a user interaction that requires another user interaction in the manufacturing process from being carried out first. It is also conceivable, for example, that a cost-intensive raw material is added last before the start of the subsequent process in order minimize or avoid rejections of the cost-intensive raw material.

In the context of the invention, it is also conceivable that the temporal course of the process parameter set is taken into account when identifying the recommended actions in order to define the action sequence. With the chronological order of the recommended actions, the recommended actions can also be integrated into the temporal course of the process parameter set in order to map the process course over time. Preferably, several action sequences can be integrated into the process course one after the other and/or at least partially in parallel. Based on the progression of temporal course of the process parameter set, it is possible to identify the best possible time, particularly in relation to the target variable, for the output of the recommended action with the display data. It can therefore be provided that the recommended actions are output with the display data depending on the chronological course of the process parameter set, i.e. in particular, each recommended action and/or each action sequence is only displayed when the respective recommended action and/or the respective action sequence is provided in the planned process course. This can simplify the timing of the recommended action for an operator. In particular, it can be provided that the operator only executes those recommended actions that are already displayed to the operator with the display data. It may be provided that a maintenance interval for maintenance of the extrusion device during the intermediate process is defined for the action sequence. This can prevent dust arising during maintenance from affecting good production in the manufacturing process and/or the subsequent process. The action sequence can also include recommended action beyond the process change.

Within the scope of the invention, it is also conceivable that the recommended actions for defining the action sequence are divided into groups in terms of time in order to allow intermediate intervals between the groups. In particular, it is conceivable that each action sequence comprises a block of recommended actions to be carried out in immediate succession. It is also conceivable that each action sequence and/or each recommended action is assigned a time that the operator requires, in particular with an additional tolerance, to execute the respective action sequence and/or recommended action. The intermediate intervals between the groups can be defined in the process course. This allows the operator to define block-by-block processing of the recommended actions in relation to the time course of the process parameter set, for example to enable an operator to operate other machines in the intermediate intervals between the action sequences

Furthermore, it is conceivable in a method according to the invention that the process course and/or the action sequence is updated depending on the user interaction, in particular whereby the display data is updated depending on the updated process course. The updated process course and/or the determination of the recommended action can be determined using a target variable for the manufacturing process, e.g. in the form of a material consumption to be minimized, a process change time to be minimized, a quality criterion for the first and/or second film material and/or a process stability criterion. The target variable can be captured by a user input. By updating the process course, the recommended actions can be adapted depending on the user interaction. This allows the process course to be adapted in the event of unforeseen actions by the operator and/or unforeseen system reactions of the extrusion device, in particular to enable an improved or optimal process change with regard to the target variable under modified conditions. This means that the operator can also be guided through the process change from a macroscopic view of the process change in a navigation-like manner if every action of the operator has an effect on the planning of the process course.

Furthermore, in a method according to the invention, it may advantageously be provided that, when determining the setpoint subsequent parameter set, parameter sets of a plurality of planned manufacturing processes are identified, a prioritization operation being carried out in which the planned manufacturing processes are compared on the basis of at least one target variable in order to determine one of the planned manufacturing processes as the subsequent process. In particular, as in relation to the process course, the target variable for the prioritization operation can be defined in the form of a material consumption to be minimized, a process change time to be minimized, a quality criterion of the first and/or second film material and/or a process stability criterion. It is conceivable that several target variables are taken into account in the prioritization operation. The planned manufacturing processes can, for example, include an order list of film materials to be produced. The prioritization operation can automatically determine the subsequent process from the planned manufacturing processes in order to coordinate the subsequent process with the current manufacturing process. This can simplify the process change. During the prioritization operation, the process parameter set of the current manufacturing process can be compared with the parameter sets of the planned manufacturing processes. For example, the recipes of the planned manufacturing processes can be checked for similarity to the recipe of the current manufacturing process during the prioritization operation. This can reduce material waste and/or the complexity of the process change for the operator during the process change.

In the context of the invention, it is also conceivable that the display data is output and/or the recommended action is determined depending on history data comprising process parameter sets and/or user interactions of previous manufacturing processes and/or of reference data comprising at least one process parameter set and/or user interactions of a reference change for the process change. In particular, the reference change can be a recorded process change, especially in which the same or similar recipes were present compared to the current process change. For example, the reference change can be carried out manually by an experienced operator, such as a lead operator, for recording. This allows other operators, who have less experience for the process change, to be guided by the reference change to perform the process change. For example, the action sequences and/or the process course can be determined using the reference change. Preferably, reference data of the reference change is output and/or displayed with the display data, in particular with the comparison elements. This allows the operator to detect at any time how his process control and/or timing compares to the reference change. It is also conceivable that the history data forms a reference. The process course can be optimized based on the previous manufacturing processes and/or process changes. For example, the process course can be planned using a majority of the history data and/or by averaging the history data. Preferably, the control system can have artificial intelligence, in particular in the form of an artificial neural network. The history data and/or the reference data can form training data for the artificial intelligence. Preferably, the process parameter set and the setpoint subsequent parameter set can be fed to the artificial intelligence as input data in order to receive the planning of the process course and/or the at least one action sequence as output data. In this way, the method can be configured to be self-learning.

Advantageously, in a method according to the invention, it can be provided that implementation data of the user interaction and/or the process change, in particular depending on the sensor data, are stored as part of the history data for provision for further subsequent processes. The implementation data can include material data, the process parameter set, the setpoint subsequent parameter set, at least one quality criterion and/or other process data. In this way, the user interaction and/or the current process change can be incorporated into the database available to the control system, thereby improving the know-how of the operation of the extrusion device in particular. In particular, if the sensor data is stored with the implementation data, a system reaction to the user interaction can also be recognized and evaluated. In particular, the evaluation can be stored using the sensor data with the implementation data. The implementation data can be used to train the artificial intelligence, for example. The method can therefore be configured to be self-learning. Furthermore, it is possible that the operator's behavior is analyzed using the implementation data in order to determine a further recommended action and/or to update the process course depending on the implementation data.

Preferably, in a method according to the invention, it can be provided that an artificial intelligence is provided to which the process parameter set and the setpoint subsequent parameter set are supplied as input data in order to receive the comparative data and/or the recommended action as output data, and/or that the implementation data and/or the history data with the sensor data, the process parameter set and the setpoint subsequent parameter set are supplied to the artificial intelligence as training data, in particular in order to supply the artificial intelligence with the input data in further subsequent processes and to receive the output data. Preferably, the control system, in particular a control device of the control system, can have the artificial intelligence, in particular in the form of an artificial neural network. The artificial intelligence can be used to create a self-learning system. Furthermore, large quantities of data can be processed by the artificial intelligence in order to optimize the process change.

Furthermore, it is conceivable in a method according to the invention that an authentication operation is carried out to identify an authorization of an operator, whereby the display data is output and/or the recommended action is determined depending on the authentication operation. In particular, the control system can comprise different user groups that have different rights. During the authentication operation, the operator himself or an authorization group can be identified. During the identification of the operator, it can be checked whether the operator is assigned to one of the authorization groups and/or to which of the authorization groups the operator is assigned. For example, the authentication operation can be used to define a level of detail for the recommended actions in the display data. It is also conceivable that the display data can be personalized based on the identification of the authorization. This means that the recommended action can be personalized to simplify the process change for the operator. Furthermore, recipes and/or user interfaces can have write protection, which can be removed depending on the authentication operation. Furthermore, it may be provided that the process course and/or the reference change can be modified depending on the authorization of the operator.

Furthermore, in a method according to the invention, it may advantageously be provided that a balancing of a quantity of the first film material and/or a quantity of a material ingredient introduced into the extrusion device is carried out, in particular wherein the determination of the recommended action and/or the planning of the process course is carried out depending on the balancing. The balancing can be carried out for the part of the manufacturing process that has already been executed. In particular, the manufacturing process can be divided into several process phases, for each of which the balancing is carried out separately. For example, the process phases can include a start phase for starting the manufacturing process, a good production, a bad production and/or phases of different film qualities. In particular, the quantity of the first film material and/or the introduced material ingredient can be measured for balancing. The quantity of the first film material and/or the introduced material ingredient may comprise a weight. The quantity of the first film material may further be performed by identifying the linear meters of the first film material produced, an area of the first film material produced, and/or a number of wraps produced. The quantity of material ingredient introduced may, for example, be measured in and/or upstream of one or more extruders of the extrusion device. However, it is also conceivable that the balancing is carried out on the basis of one or more user inputs. A prompt can be issued to the user for this purpose.

Preferably, in a method according to the invention, it can advantageously be provided that, preferably for determining the recommended action, a process inflection point is determined on the basis of the balancing and/or on the basis of the process completion, from which a continuation of the manufacturing process is no longer possible while maintaining a quality criterion and/or a process stability criterion of the first film material. Preferably, after the process inflection point, the process change to the subsequent process is forced, in particular electronically. For example, an extension of the manufacturing process can be initiated automatically and/or by an operator before the process inflection point and/or prevented, in particular electronically, after the process inflection point. The process inflection point can be output as information for an operator, in particular displayed with the display data. In particular, the process inflection point can be used to prevent bad production from occurring unnoticed, e.g. due to user interaction during the manufacturing process, which then turns into good production again by subsequently extending the manufacturing process. Furthermore, it can be provided that, in particular before the recommended action is issued and/or before the user interaction, confirmation of the process inflection point by an operator is expected. This can prevent the process inflection point from being reached without the consent of the operator, in particular through the preparatory measure.

Furthermore, it is conceivable within the scope of the invention that a material flow within the extrusion device for the process change is identified depending on the process parameter set and the target process parameter set, with the identification of the comparative data, the planning of the process course and/or the determination of the recommended action being carried out depending on the material flow. When identifying the material flow, the material flow can advantageously be calculated and/or determined empirically, in particular analytically and/or numerically. For example, it is conceivable that an observed material flow is extrapolated over a certain period of time. To identify the material flow, the process parameter set and the target process parameter set can be used to provide information about boundary conditions and/or material ingredients. For example, the process parameter set and the target process parameter set can be used to determine whether certain actions, such as a rinsing operation, are required for the process change in order to set up the subsequent process based on the target process parameter set. These actions can determine the material flow, e.g. of a rinsing material. It is possible that, depending on the material flow, an operator query is made as to the time at which a material ingredient and/or the rinsing material should reach the film bubble. It is also conceivable that the process parameter set can be used to determine material data, in particular to map the material behavior of at least one first material ingredient used in the manufacturing process, and the target process parameter set can be used to determine subsequent material data, in particular to map the material behavior of at least one second material ingredient used in the subsequent process instead of the first material ingredient. In this way, the material course can be simulated in particular in order to calculate the process course at least partially in advance. As a result, the comparative data and/or the recommended action can be improved.

According to a further aspect of the invention, there is provided a computer program product comprising instructions which, when executed by a control system, cause the control system to execute a method according to the invention.

Thus, a computer program product according to the invention has the same advantages as those already described in detail with reference to a method according to the invention. In particular, the method may be a computer-implemented method. The computer program product may be implemented as computer-readable instruction code. Further, the computer program product may be stored on a computer-readable storage medium such as a data disk, a removable drive, a volatile or non-volatile memory, or a built-in memory/processor. Furthermore, the computer program product can be provided or made available on a network, such as the Internet, from which it can be downloaded or executed online by a user as required.

The computer program product can be realized through software as well as through one or more special electronic circuits, i.e. in hardware or in any hybrid form, i.e. through software components and hardware components.

According to a further aspect of the invention, a system for user guidance is provided. The system comprises an extrusion device for implementation of a manufacturing process for manufacturing a first film material. Further, the system comprises a control system for implementing a method according to the invention.

Thus, a system according to the invention has the same advantages as those already described in detail with reference to a method according to the invention and/or a computer program product according to the invention. The control system may preferably comprise a monitoring device, in particular comprising a processor and/or microprocessor, for executing the method. Furthermore, the monitoring device can be integrated into a control device of the extrusion device and/or into a control center. The control center can comprise a server and/or a cloud. It is also conceivable that the control system has several, in particular distributed, monitoring devices for executing the method. Furthermore, the control system can comprise a memory device and/or a database for providing the setpoint subsequent parameter set, the history data and/or the reference data. The system may further comprise a display device for displaying the display data. For example, the display device may comprise a display and/or a touch screen. Advantageously, the display device can be integrated into the extrusion device and/or the control station. It is also conceivable that the display device is a mobile terminal device, such as a smartphone or a pager.

Further advantages, features and details of the invention are apparent from the following description, in which embodiments of the invention are described in detail with reference to the drawings. The features mentioned in the claims and in the description may be essential to the invention individually or in any combination. It shows schematically:

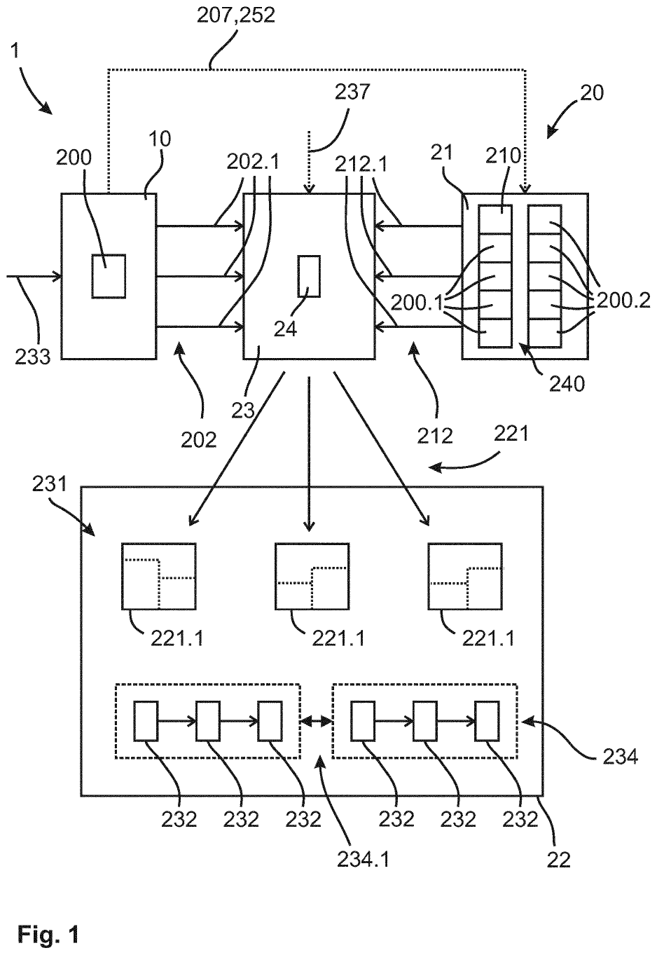

FIG. 1 a system according to the invention when carrying out a method according to the invention,

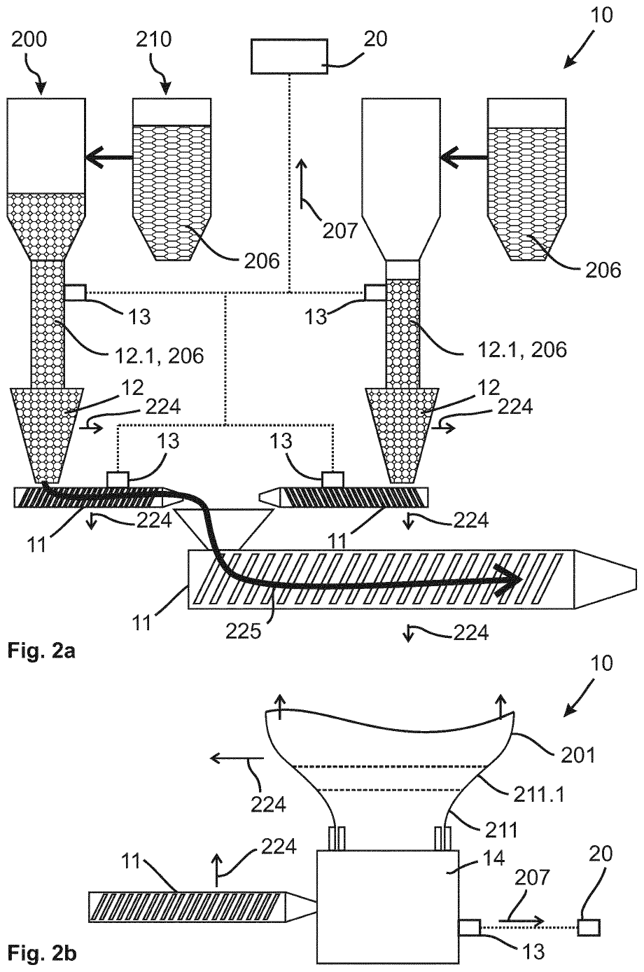

FIGS. 2a & 2b parts of an extrusion device of the system during a process change,

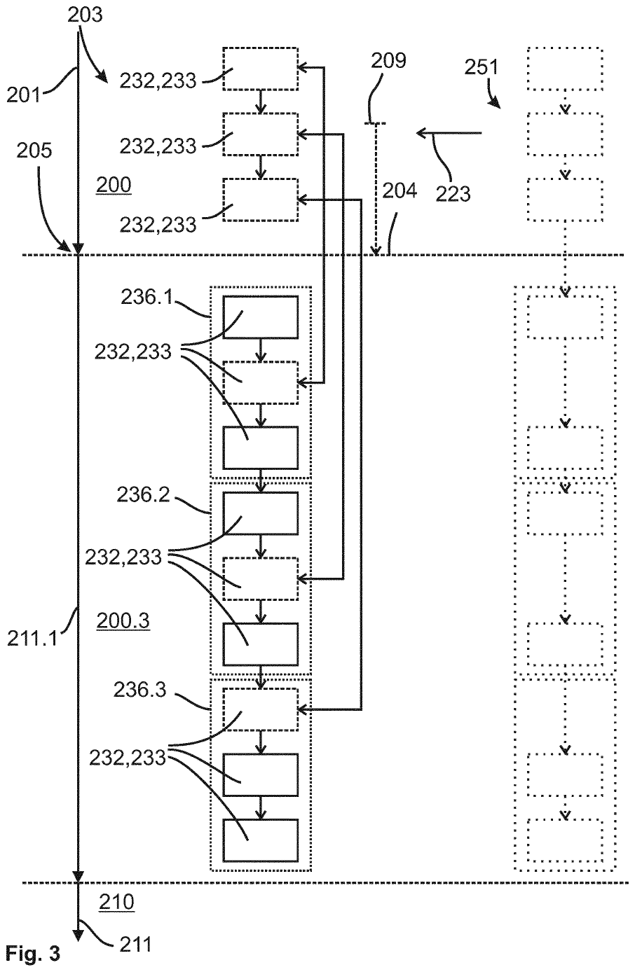

FIG. 3 a process course during the process change,

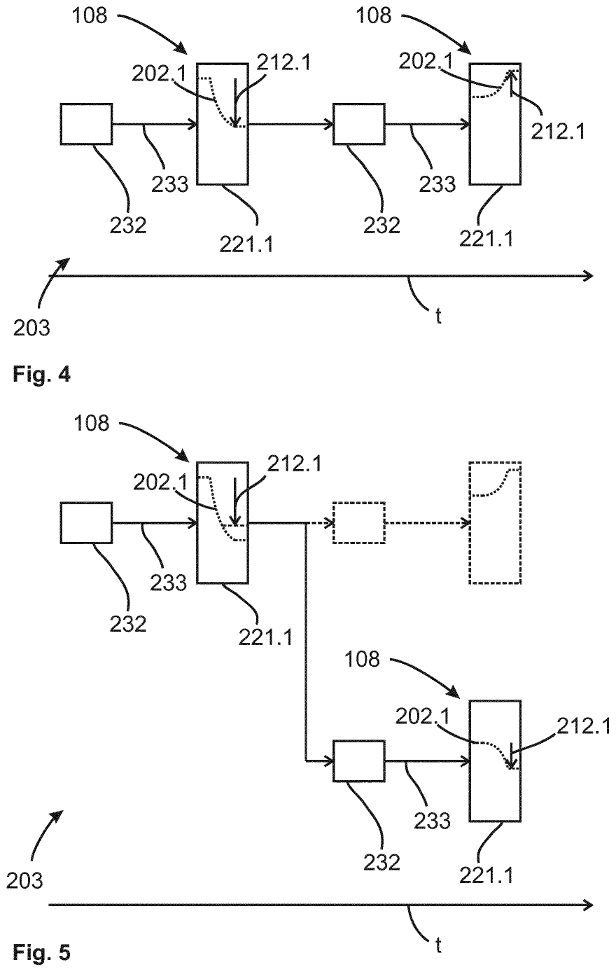

FIG. 4 user interactions of the process course for the process change,

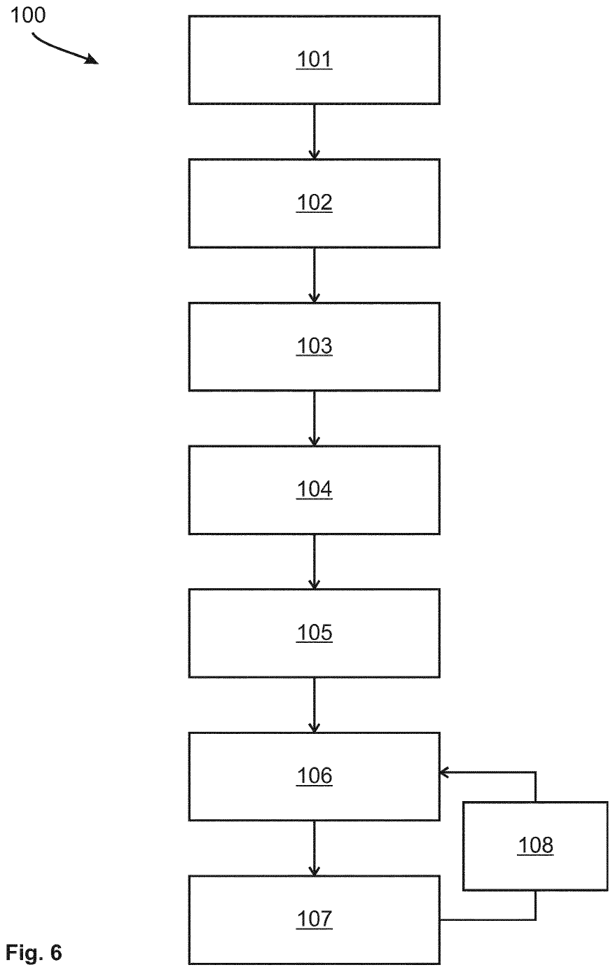

FIG. 5 a correction of the process course after a system reaction, and

FIG. 6 a method with a schematic representation of the method stages.

In the following description of some embodiments of the invention, the identical reference signs are used for the same technical features even in different embodiments.

FIG. 1 shows a system 1 according to the invention when executing a method 100 according to the invention for user guidance for a process change from a manufacturing process 200 for supporting at least a process change from a manufacturing process 200 for manufacturing a first film material 201 to a subsequent process 210 for manufacturing a second film material 211 in a first embodiment. The manufacturing process 200 for manufacturing a first film material 201 is implemented by the extrusion device 10. As shown in FIGS. 2a and 2b, the extrusion device 10 comprises a plurality of extruders 11 for extruding a plastic material. Furthermore, the extrusion device 10 has a plurality of feed devices 12 through which the extruders 11 are fed with different material ingredients 206. As shown in FIG. 2b, the extrusion device 10 in the present embodiment is a blown film machine with a film blowing head 14 for producing a film bubble, in the region of which the first film material 201 cools. However, it is also conceivable that the extrusion device 10 of system 1 is a cast film machine, for example.

When an order for the production of the first film material 201 is completed, the process change from the manufacturing process 200 of the first film material 201 to the subsequent process 210 of the second film material 211 takes place without stopping the extrusion device 10. As shown in FIG. 2b, the process change can comprise a transition from the first film material 201 to the second film material 211. The transition may, for example, be generated stagelessly and/or by performing an intermediate process 200.3 to generate an intermediate material 211.1 in order to simplify and/or enable the process change. To support the process change from the manufacturing process 200 to the subsequent process 210, the system 1 comprises a control system 20, in particular comprising a monitoring device 23 in the form of a processor and/or microprocessor, for implementing the method 100. Preferably, a computer program product may be provided comprising instructions which, when executed by the control system 20, cause the control system 20 to execute the method 100. Method stages of the method 100 are shown schematically in FIG. 6.

In the method 100, a process parameter set 202 of the manufacturing process 200 for manufacturing the first film material 201 is first captured 101 by the extrusion device 10. The process parameter set 202 can preferably comprise sensor data 207 from sensors 13 of the extrusion device 10. Thus, the process parameter set 202 may comprise actual machine data of the extrusion device 10, at least some of which is measured directly at the extrusion device 10. Furthermore, the process parameter set 202 may comprise predetermined data for the manufacturing process 200. For example, the process parameter set 202 may comprise material data of material ingredients 206, i.e. in particular raw materials, and/or control and/or regulation data for controlling the extrusion device 10 by the monitoring device. The manufacturing process 200 can be defined, preferably completely, by the process parameter set 202.

Furthermore, the method 100 involves determining 102 a setpoint subsequent parameter set 212 of the subsequent process 210 associated with the process parameter set 202. As shown in FIG. 1, the process parameter set 202 has, in particular, a plurality of process parameters 202.1. For each of the process parameters 202.1, the setpoint subsequent parameter set 212 can have a setpoint sequence parameter 212.1. Consequently, the subsequent process 210 can be defined, preferably completely, by the setpoint subsequent parameter set 212. The subsequent process 210 can be captured by a user input and/or retrieved from a memory device 21 of the control system 20. Advantageously, parameter sets of several planned manufacturing processes 200.1 can be identified when determining 102 the setpoint subsequent parameter set 212. The planned manufacturing processes 200 can be stored as an order list in the memory device 21 of the control system 20. The subsequent process 210 can be determined by performing a prioritization operation in which the planned manufacturing processes 200.1 are compared on the basis of at least one target variable. One of the planned manufacturing processes 200.1 can be determined as the subsequent process 210 for the current manufacturing process 200, which is as optimal as possible in relation to the target variable. It is conceivable that an order of the planned manufacturing processes 200.1 is determined when determining 102 the setpoint subsequent parameter set 212.

Based on a comparison of the process parameter set 202 with the setpoint subsequent parameter set 212, an identification 103 of comparative data 221 for detecting deviations of the setpoint subsequent parameter set 212 from the process parameter set 202 is also carried out in the method 100, in particular by the monitoring device 23. For example, a difference between the target sequence parameters 212.1 and the process parameters 202.1 can be identified in order to identify, for example, control data and/or system changes that enable the process change. The comparative data 221 form a basis for displaying comparison elements 221.1.

Depending on the comparative data 221, at least one process course 203 for the manufacturing process 200 and/or the subsequent process 210 is also planned 104. The process course 203 is shown in FIG. 3. In particular, the process change comprises the intermediate process 200.3, in which an intermediate material 211.1 is produced in order to enable a transition of the first film material 201 to the second film material 211. During the manufacturing of the intermediate material 211.1, for example, material ingredients 206 of the second film material 211 can be added in stages.

As shown in FIG. 4, the process course 203 also defines, in particular, temporal modification in a temporal course of the process parameter set 202 over a time t. The process course 203 comprises a sequence of user interactions 233 and the resulting system reactions of an at least partial adjustment of process parameters 202.1 to the respectively assigned target sequence parameter 212.1.

Based on the process course 203, the control system 20 determines 105 at least one recommended action 232 depending on the comparative data 221. The recommended action 232 comprises information for recommending a user interaction 233 in the form of a manual activity and/or a control of the extrusion device 10. It may be provided that when determining 105 the recommended action 232, a plurality of recommended actions 232 are identified for defining an action sequence 234 with a chronological order of the recommended actions 232, in particular on the basis of the process course 203. To define the action sequence 234, the temporal course of the process parameter set 202 is taken into account when identifying 103 the recommended actions 232. This allows the optimum sequence for the process change to be defined at the time of determining 105 the recommended action 232. It is advantageous if the recommended actions 232 for defining the action sequence 234 are divided into groups in terms of time, in order to allow intermediate intervals 234.1 between the groups. This allows an operator to carry out other work, such as operating a second extrusion device 10 or supporting another operator, in the intermediate intervals 234.1.

As can be seen from FIG. 3, it can be advantageous if certain user interactions 233 of the process change can already be executed during the manufacturing process 200 and/or can be prepared by visualization and/or by actions of the operator and/or the control system 20, in particular if the change conditions of the process change are known on the basis of the comparative data 220. Furthermore, the user interactions 233 can be executed at least partially during the intermediate process 200.3. The user interactions 233 may comprise manual activities and/or control actions for controlling the extrusion device 10. The recommended actions 232 can each comprise at least one piece of information for recommending at least one user interaction 233 for a rinsing operation 236.1, an adjustment 236.2 of a process parameter 202.1 in the form of a temperature of the extrusion device 10 and/or a modification 236.3 of the process data 202 for maintaining a bubble stability of a film bubble, in particular during the adjustment 236.2 of the temperature. Furthermore, it is conceivable that the recommended actions 232 comprise a modification of a material supply 12.1 and/or a start process for the intermediate process 200.3.

For improved prediction of the process course 203, a balancing 224 of a quantity of the first film material 201 and/or a quantity of a material ingredient 206 introduced into the extrusion device 10 can be performed. Furthermore, a material flow 225 within the extrusion device 10 for the process change can be identified depending on the process parameter set 202 and the target process parameter set 212. The balancing 224 and/or the material flow 225 can then be used to determine 105 the recommended action 232 and/or to plan 104 the process course 203. As a result, the process change can be at least partially material-controlled. In particular, to determine 105 the recommended action 232, a process inflection point 209 is determined on the basis of the balancing 224 and/or on the basis of the process completion 204, from which a continuation of the manufacturing process 200 is no longer possible while maintaining a quality criterion of the first film material 201. The process inflection point 209 can be output by the display data 231. After the process inflection point 209, the process change to the subsequent process 210 can be forced electronically by the monitoring device 23.

For user guidance, the method 100 further comprises an output 106 of display data 231 for joint displaying a plurality of comparison elements 221.1 for displaying the deviations based on the comparative data 221 during the manufacturing process 200. It may be determined that each of the comparison elements 221.1 comprises a single comparison for each of the process parameters 202.1 with the associated target sequence parameter 212.1 into the display data 231. Preferably, the comparison elements 221.1 comprise a selection of comparisons of the process parameters 202.1 with the associated target sequence parameters 212.1 and/or a processing of the comparison of the process parameter set 202 and the setpoint subsequent parameter set 212. For example, the comparative data 221 may comprise a predefined selection of individual comparisons of process parameters 202.1 with the respective associated target sequence parameter 212.1 and/or a calculation of characteristic numbers for visualizing the comparison. The display data 231 comprise the comparison elements 221.1, in particular in the form of a visualization of the comparative data 221, for example with graphical elements. As shown in FIG. 1, the display data 231 is sent from a monitoring device 23 of the control system 20 to a display device 22 when the display data 231 is output 106, through which the joint display of the comparison elements 221.1 takes place. Furthermore, the action sequence 234 and/or the recommended action 232 is taken into account in the display data 231. As a result, an operator immediately receives an indication of which user interaction 233 is to be carried out based on the comparative data 221.

The output 106 of the display data 231 and/or the determination 105 of the recommended action 232 may be performed depending on history data 250 and/or reference data 223. The history data 250 may comprise process parameter sets 202 and/or user interactions 233 of previous manufacturing processes 200.2. The reference data 223 may include at least one process parameter set 202 and/or user interactions 233 of a reference change 251 for the process change. The reference change 251 may be a process change that is or has been performed by an experienced operator, in particular a lead operator. In particular, the reference data 223 may comprise a record of the reference change 251.

Subsequently, one of the user interactions 233 for controlling the extrusion device 10 to at least partially adjust the process parameter set 202 is captured 107. The user interaction 233 may comprise specifying an adjusted value for one of the process parameters 202.1 of the process parameter set 202. For example, the user interaction 233 may take the form of a user input directly at the display device 22 to control the extrusion device 10. However, it is equally conceivable that the user interaction 233 comprises a manual activity to control the extrusion device 10, such as moving a component, opening a valve and/or the like. When capturing 101 the user interaction 233, in particular a control instruction and/or a system response of the extrusion device 10 may be recognized. For example, the user interaction 233 can be captured by modifying the process parameter set 202 or by specifying a target value for a process parameter 202.1 of the process parameter set 202.

Depending on the adjustment of the process parameter set 202, preferably during the manufacturing process 200, the method 100 further comprises updating 108 the display data 231. For this purpose, for example, the identification 103 of the comparative data 221 can be repeated with the adapted process parameter set 202. When updating 108 the display data 231, in particular the comparison elements 221 are updated, preferably by visualizing the system responses to the respective user interaction 233, as shown in FIGS. 4 and 5, by the comparison elements. Furthermore, as shown in FIG. 5, the process course 203 and/or the action sequence 234 can be updated depending on the user interaction 233. In this way, the process course 203 can be adapted in the event of unforeseen actions of the operator and/or unforeseen system reactions of the extrusion device 10 in order to navigate the user through the process change as optimally as possible.

It may be provided that an authentication operation 237 is carried out to identify an authorization of an operator, depending on which the display data 231 is output 106 and/or the recommended action 232 is determined 102. This allows the display data 231 to be individually configurable. Furthermore, it can be ensured that the recommended action 232 is suitable for an authorization level of the identified operator. For example, an experienced operator can be allowed more freedom when changing processes and/or the recommended action 232 can be configured in less detail.

Furthermore, in particular depending on the sensor data 207, implementation data 252 of the user interactions 233 are preferably stored in the memory device 22 of the control system 20, in particular as part of the history data 250 for provision for further subsequent processes 210, in order to achieve a learning effect and an improvement of the know-how, in particular internal know-how, on the basis of the implementation data 252. In particular, the monitoring device 23 may have an artificial intelligence 24 to which the process parameter set 202 and the setpoint subsequent parameter set 212 are fed as input data in order to receive the comparative data 221 and/or the recommended action 232 as output data. Additionally or alternatively, the artificial intelligence 24 may be fed the implementation data 252 and/or the history data 250 with the sensor data 207, the process parameter set 202 and the setpoint subsequent parameter set 212 of the artificial intelligence 24 as training data.

Thus, the method 100 comprises in particular a dynamic process control for interaction of a user with the extrusion device 10, in particular at least partially already during the ongoing manufacturing process 200, in order to prepare the subsequent process 210. Certain stages can be carried out before the manufacturing process 200 is completed. The measures preparing for the process change can shift the process change at least partially into the manufacturing process 200 and thus preferably blur a boundary between the manufacturing process 200 and the subsequent process 210. By joint displaying the comparative data 221 during the manufacturing process 200, both experienced and inexperienced users can receive a comprehensive overview of the current process parameter set 202 and of the adjustments to be made for the subsequent process 210 at any time. Furthermore, by updating 108 the display data 231, a navigation-like, continuous check can be made as to whether the current adjustments meet the requirements of the manufacturing process 200 and/or the subsequent process 210. In doing so, the operator can be shown an optimal path for the process change with each update 108 of the display data 231. In this way, operating errors and/or unfavorable operating actions can be detected in order to enable a counter-reaction.

The foregoing explanation of the embodiments describes the present invention solely by way of examples. Of course, individual features of the embodiments may be freely combined with one another, provided that this is technically expedient, without departing from the scope of the present invention.

### LIST OF REFERENCE SYMBOLS

1 System
10 Extrusion device
11 Extruder
12 Feed device
12.1 Material supply
13 Sensor
14 Film blowing head
20 Control system
21 Memory device
22 Display device
23 Monitoring device
100 Method
101 Capturing 202
102 Determining 212
103 Identifying 221
104 Planning 203
105 Determining 232
106 Outputting from 231
107 Capturing of 233
108 Update 230
200 Manufacturing process
200.1 Planned manufacturing process
200.2 Previous manufacturing process
200.3 Intermediate process
201 First film material
202 Process parameter set
202.1 Process parameters
203 Process course
206 Material ingredient
207 Sensor data
210 Subsequent process
211 Second film material
211.1 Intermediate material
212 Setpoint subsequent parameter set
212.1 Target sequence parameters
221 Comparative data
221.1 Comparison element
223 Reference data
224 Balancing
231 Display data
232 Recommended action
233 User interaction
234 Action sequence
234.1 Intermediate intervals
236.1 Rinsing operation
236.2 Adjustment of a temperature
236.3 Modification of 202 to maintain stability of the film bubble
237 Authentication operation
250 History data
251 Reference change
252 Implementation data
t Time

1. A Method for user guidance for a process change from a manufacturing process for manufacturing a first film material to a subsequent process for manufacturing a second film material in an extrusion device, comprising:
capturing a set of process parameters of the manufacturing process for manufacturing the first film material,
determining a setpoint subsequent parameter set of the subsequent process assigned to the process parameter set,
identifying of comparative data of a comparison of the process parameter set with the setpoint subsequent parameter set for detecting deviations of the setpoint subsequent parameter set from the process parameter set,
outputting of display data for joint display of a plurality of comparison elements for displaying the deviations on the basis of the comparative data during the manufacturing process,
capturing a user interaction for controlling the extrusion device to at least partially adjust the process parameter set,
updating the display data depending on the adjustment of the process parameter set.

2. The method according to claim 1,
wherein
at least the process parameter set and/or the comparison elements comprise at least material data from material ingredients and/or sensor data from sensors of the extrusion device.

3. The method according to claim 1,
wherein
the method comprises the following stage:
determining at least one recommended action for adjusting the process parameter set for the subsequent process depending on the comparative data,
whereby the recommended action is output with the display data.

4. The method according to claim 1,
wherein
the recommended action comprises at least a manual activity or a recommendation for controlling the extrusion device.

5. The method according to claim 1,
wherein
the method comprises the following stages:
planning of at least one process course at least for the manufacturing process or the subsequent process depending on the comparative data.

6. The method according to claim 1,
wherein
the process course for defining temporal modifications comprises at least a temporal course of the process parameter set, the output of the display data or the determination of the recommended action taking place depending on the temporal course.

7. The method according to claim 1,
wherein
when determining the recommended action, a plurality of recommended actions for defining an action sequence are identified.

8. The method according to claim 1,
wherein
the time course of the process parameter set is taken into account when identifying the recommended actions in order to define the action sequence.

9. The method according to claim 1,
wherein
the recommended actions for defining the action sequence are divided into groups in order to allow intermediate intervals between the groups.

10. The method according to claim 1,
wherein
at least the process course or the action sequence is updated depending on the user interaction.

11. The method according to claim 1,
wherein
when determining the setpoint subsequent parameter set, parameter sets of a plurality of planned manufacturing processes are identified, a prioritization operation taking place in which the planned manufacturing processes are compared on the basis of at least one target variable in order to determine one of the planned manufacturing processes as the subsequent process.

12. The method according to claim 1,
wherein
at least the output of the display data or the determination of the recommended action takes place at least depending on history data, which comprise at least process parameter sets or user interactions of previous manufacturing processes, or of reference data, which at least comprise at least one process parameter set or user interactions of a reference change for the process change.

13. The method according to claim 1,
wherein
implementation data of the user interaction, is stored as part of the history data for provision for further subsequent processes.

14. The method according to claim 1,
at least wherein
an artificial intelligence is provided, to which the process parameter set and the setpoint subsequent parameter set are fed as input data in order to receive at least the comparative data or the recommended action as output data, or wherein at least the implementation data or the history data are fed to the artificial intelligence as training data together with the sensor data, the process parameter set and the setpoint subsequent parameter set.

15. The method according to claim 1,
wherein
an authentication operation for identifying an authorization of an operator is carried out, wherein at least the output of the display data or the determination of the recommended action being carried out depending on the authentication operation.

16. The method according to claim 1,
wherein
a balancing of at least a quantity of the first film material or a quantity of a material ingredient introduced into the extrusion device is carried out.

17. The method according to claim 1,
wherein
in order to determine the recommended action, a process inflection point is determined at least on the basis of the balancing or on the basis of the process completion, from which point it is no longer possible to continue the manufacturing process while maintaining a quality criterion of the first film material.

18. The method according to claim 1,
wherein
a material flow within the extrusion device for the process change is identified depending on the process parameter set and the target process parameter set, wherein at least the identification of the comparative data, the planning of the process course or the determination of the recommended action being carried out depending on the material flow.

19. A computer program product comprising instructions which, when executed by a control system, the control system to execute a method according to claim 1.

20. A System for user guidance for a process change comprising:
an extrusion device for implementing a manufacturing process for manufacturing a first film material, and
a control system for implementing a method according to claim 1.
